(19) United States
(12) Patent Application Publication
(10) Pub. No.: US 2012/0317998 A1
(43) Pub. Date: Dec. 20, 2012

(54) METHOD AND DEVICE FOR EVAPORATION OF CRYOGENIC MEDIA

(75) Inventor: Fokke Bokker, Munchen (DE)

(73) Assignee: LINDE AKTIENSGESELLSCHAFT, Munchen (DE)

(21) Appl. No.: 13/513,233

(22) PCT Filed: Nov. 30, 2010
(86) PCT No.: PCT/EP2010/007246

§ 371 Date: Aug. 16, 2012

(30) Foreign Application Priority Data
Dec. 4, 2009 (DE) 10 2009 057 055.1

(51) Int. Cl. F17C 9/02

(52) U.S. Cl. 62/50.2

(57) ABSTRACT

The invention relates to a method and a device for increasing the enthalpy of a medium, in which energy is withdrawn from a first heat carrier (W) consisting of a first flue gas (5) and a second heat carrier (W) comprising water and flue gas and, in each case, is transmitted to the medium via indirect heat exchange, wherein a second flue gas (3) is injected into a water-containing system of matter for formation of the second heat carrier (W). The first heat carrier (9) that is cooled against the medium is used for formation of the second heat carrier (W).

The invention relates to a method for increasing the enthalpy of a medium, in which energy is withdrawn from a first heat carrier consisting of a first flue gas and a second heat carrier comprising water and flue gas and, in each case, is transmitted to the medium via indirect heat exchange, wherein a second flue gas is injected into a water-containing system of matter for formation of the second heat carrier.

In addition, the invention relates to a device for carrying out the method.

Devices in which a heat carrier formed of water and flue gas are used for increasing the enthalpy of a medium have been prior art for many years and are known to those skilled in the art under the names TX LNG evaporators and Sub-X® heat exchangers. This technology is used, in particular, for warming and/or for vaporizing cryogenic media such as carbon dioxide, liquid natural gas and liquid nitrogen.

The medium to be warmed and/or to be vaporized is conducted through the tubes of a tube-bundle heat exchanger which is arranged in a container and is completely surrounded by a heat carrier consisting of water and flue gas. Hot flue gas from a burner is fed to the container and injected into the heat carrier below the heat exchanger. The gas bubbles forming in this case ensure, owing to their buoyancy, the formation of a turbulent flow, and so the heat carrier flows at high flow velocity around the tubes of the heat exchanger. Owing to the high surface area of the gas bubbles, the flue gas is very effectively cooled, and so its temperature rapidly falls to values at which condensable substances—in particular water—condense out. In addition to the sensible heat, the latent heat stored in the flue gas can also be utilized for the vaporization and/or the warming of the cryogenic medium by this means. Owing to the flow ratios, a large heat transfer coefficient results between the water-flue gas mixture and the heat-exchanger tubes, as a result of which it is possible to construct the heat exchanger so as to be very compact.

Even under the assumption of infinitely large heat exchanger surfaces, using the described method, the temperature of the cryogenic medium can be increased at most up to the temperature of the water-flue gas mixture. In practice, the medium assumes a temperature which is typically approximately 10° C. lower than the temperature of the heat carrier. With increasing temperature of the water-flue gas mixture, the efficiency of the method falls, since more and more water vaporizes and is removed into the atmosphere together with the cooled flue gas. It has proved to be expedient to keep the water-flue gas mixture at a temperature of below 30° C., but preferably even below 15° C. Owing to these restrictions, the maximum achievable end temperature of the medium is therefore restricted to approximately 20° C.

If a final temperature of the medium of above 20° C. is demanded, a further process step is required, in which the medium is further warmed in a downstream heat exchanger. If in this case a flue gas is used as heat carrier, the warming proceeds with a comparatively poor efficiency, since water vapour present in the flue gas remains in the gas phase and the heat of condensation thereof is removed to the atmosphere without being utilized.

It is the object of the invention to specify a method of the type mentioned at the outset and also a device for carrying out the same, by which the disadvantages of the prior art are overcome.

The object in question is achieved according to the invention in terms of the method in that the first heat carrier cooled against the medium is used for formation of the second heat carrier.

Via the method according to the invention, it is possible to make energy stored in the cooled first heat carrier usable for increasing the enthalpy of the medium. In particular, water vapour present is condensed and the resultant heat of condensation is transferred to the water of the second heat carrier. Since the heat of condensation is returned to the process and is not lost to the atmosphere, a medium that is warmed and/or vaporized against the second heat carrier can be further warmed against the second heat carrier without this being associated with a decrease in the thermal efficiency, as in the prior art.

In a development of the method according to the invention, it is proposed that, for formation of the second heat carrier, the cooled first flue gas is injected into the water-containing system of matter independently of the second flue gas or together therewith.

The flue gases required for the two heat carriers are generated by combustion of a fuel in a burner to which, expediently, air or oxygen-enriched air or another oxygen-containing gas mixture is fed as oxidizing agent. In a departure from the language usual in chemistry, in the context of the present invention, only those substances or mixtures of matter are termed oxidizing agents which contain oxygen and can give this off in a reaction with a fuel. Preferably, the first flue gas is generated in a burner, whereas, for generating the second flue gas, a second burner is used. A variant of the method according to the invention, however, provides the use of only one burner, in which not only the first but also the second flue gas are generated.

In a preferred embodiment of the method according to the invention, the first heat carrier is generated as oxygen-containing flue gas, for which purpose a first fuel is burnt under oxygen excess. After cooling thereof against the medium, the oxygen-containing flue gas is rationally fed as oxidizing agent in its entirety to the burner in which the second flue gas is generated by the combustion of a second fuel. Ideally, the first flue gas is generated in such a manner that oxygen is fed to the second burner with the cooled first flue gas in an amount which is sufficient for complete oxidation of the second fuel. If the amount of oxygen fed with the first flue gas is not sufficient for complete oxidation of the second fuel, the invention provides that in addition a further oxidizing agent, which is preferably air, is fed to the second burner.

The method according to the invention is suitable, in particular, for vaporizing a cryogenic liquid, such as, for example, liquefied natural gas, liquid ethylene, liquid carbon dioxide or liquid nitrogen, and to superheat the gas phase formed in this process to a temperature of above 20° C. However, it can also be used for warming a supercritical medium or a cryogenic gas, such as carbon dioxide, for example.

In addition, the invention relates to a device for increasing the enthalpy of a medium using a burner for generating a first flue gas and a burner for generating a second flue gas, and using a first heat exchanger and a second heat exchanger, wherein in the first heat exchanger, energy is withdrawn from a first heat carrier consisting of the first flue gas, and in the second heat exchanger, energy is withdrawn from a second heat carrier, and in each case can be transferred by indirect heat exchange to the medium, said device also having a mixing appliance in which water can be mixed with flue gas for formation of the second heat carrier and in which the second heat exchanger is arranged.

The object in question is achieved according to the invention in terms of the device in that it comprises a feed appliance, via which the first heat carrier that is cooled against the medium can be introduced into the mixing appliance for formation of the second heat carrier.

The feed appliance in this case can be constructed in such a manner that it permits a modification of the chemical composition of the cooled first heat carrier before this is introduced into the mixing appliance.

An embodiment of the device according to the invention provides that the mixing appliance is connected to a feed appliance or feed appliances via which the first flue gas and the second flue gas can be introduced together or separately into the mixing appliance.

Another embodiment of the device according to the invention provides that the burner for generating the first flue gas is identical to or different from the burner for generating the second flue gas.

A further embodiment of the device according to the invention provides that the burner for generating the second flue gas is connected to an appliance via which the first flue gas that is cooled against the medium can be fed as oxidizing agent thereto.

The device according to the invention is suitable for increasing the enthalpy of any type of medium. However, particularly advantageously, it can be used for vaporizing a cryogenic liquid and warming the resultant gas phase to a temperature of above approximately 20° C.

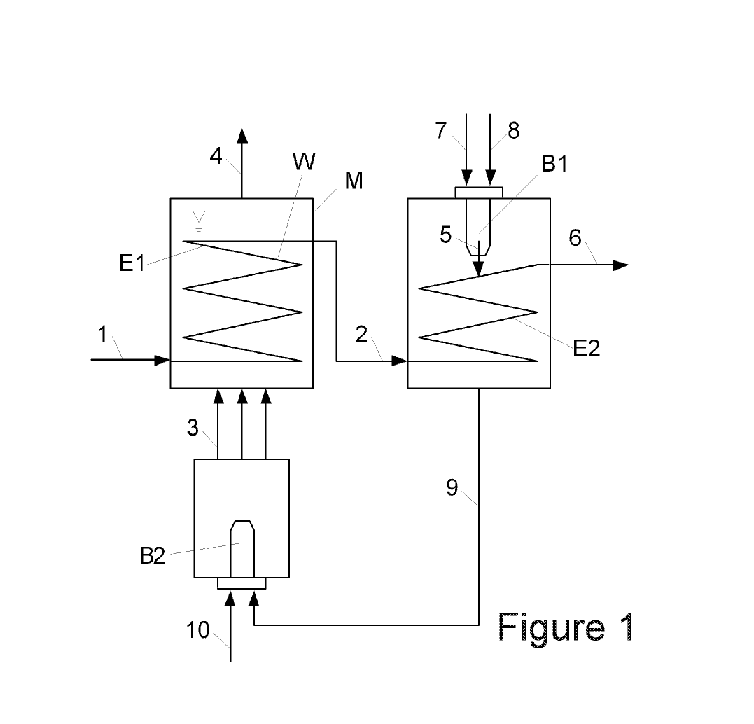

Hereinafter, the invention is to be described in more detail with reference to an exemplary embodiment shown schematically in FIG. 1.

The exemplary embodiment shows a device for vaporizing a cryogenic liquid such as, for example, liquid natural gas or liquid nitrogen, and also for superheating the gas phase formed in the vaporization.

Via conduit 1, the cryogenic liquid is introduced into the heat exchanger E1 which is arranged in the mixing appliance M and is surrounded by the heat carrier W which is a water-gas mixture. Via indirect heat exchange, heat is transferred from the heat carrier W to the cryogenic liquid, as a result of which this vaporizes. Via a conduit 2, a gas phase is withdrawn from the mixing appliance M, the temperature of which gas phase is approximately 10° C. lower than the temperature of the heat carrier W, which is typically about 20° C. In order to supply heat to the heat carrier W, via the conduits 3, flue gas is fed to the mixing appliance M and injected into the heat carrier W below the heat exchanger E1, where it is distributed in the form of small bubbles. In this case, the flue gas 3 cools rapidly in direct contact with the water to the extent that condensable substances present therein—primarily water vapour—condense. Exactly like its sensible heat, the heat of condensation being liberated in this process is given off to the water, as a result of which it is possible to utilize not only the lower heating value, but also the higher heating value, of the flue gas 3. The cooled flue gas is withdrawn via conduit 4.

The gas phase 2 generated in the heat exchanger E1 is passed on to the heat exchanger E2 where it is superheated in indirect heat exchange against a flue gas 5 generated in the burner B1. The superheated gas phase is taken off via conduit 6. In the burner B1, a fuel 7, such as natural gas, for example, is burnt with an oxidizing agent 8, which is usually air. The combustion is carried out under oxygen excess, as a result of which the resultant flue gas contains oxygen. This flue gas is not cooled to below the dew point of the water present therein, such that, via conduit 9, an oxygen-containing flue gas is withdrawn which, in addition to its sensible heat, also still contains latent heat. The cooled flue gas, owing to the oxygen content and amount thereof, can be fed to the burner B2 as oxidizing agent, with which the fuel 10 is completely oxidized and converted to the flue gas 3.

1. Method for increasing the enthalpy of a medium, in which energy is withdrawn from a first heat carrier (W) consisting of a first flue gas (5) and a second heat carrier (W) comprising water and flue gas and, in each case, is transmitted to the medium via indirect heat exchange, wherein a second flue gas (3) is injected into a water-containing system of matter for formation of the second heat carrier (W), characterized in that the first heat carrier (9) that is cooled against the medium is used for formation of the second heat carrier (W).

2. Method according to claim 1, characterized in that, for formation of the second heat carrier (W), the cooled first flue gas (9) is injected into the water-containing system of matter independently of the second flue gas (3) or together therewith.

3. Method according to claim 1, characterized in that the first flue gas (5) and the second flue gas (3) are generated in the same burner or in different burners (B1, B2).

4. Method according to claim 1, characterized in that the first flue gas (5) is generated with an oxygen excess and, after cooling against the medium, is fed as oxidizing agent (9) to the burner for generating the second flue gas (3).

5. Method according to claim 1, characterized in that it is used for vaporizing and/or warming liquid natural gas or liquid ethylene or liquid nitrogen or carbon dioxide.

6. Device for increasing the enthalpy of a medium (1) using a burner (B1) for generating a first flue gas (5) and a burner (B2) for generating a second flue gas (3), and using a first heat exchanger (E2) and a second heat exchanger (E1), wherein in the first heat exchanger (E2), energy is withdrawn from a first heat carrier (W) consisting of the first flue gas (5), and in the second heat exchanger (E1), energy is withdrawn from a second heat carrier (W), and in each case can be transferred by indirect heat exchange to the medium (1, 2), said device also having a mixing appliance (M) in which water can be mixed with flue gas (3) for formation of the second heat carrier (W) and in which the second heat exchanger (E1) is arranged, characterized in that it comprises a feed appliance (9, B2, 3), via which the first heat carrier that is cooled against the medium can be introduced into the mixing appliance (M) for formation of the second heat carrier (W).

7. Device according to claim 6, characterized in that the mixing appliance (M) is connected to a feed appliance (3) via which the first flue gas and the second flue gas can be introduced together or separately into the mixing appliance (M).

8. Device according to claim 1, characterized in that the burner (B1) for generating the first flue gas (5) is identical to or different from the burner (B2) for generating the second flue gas (3).

9. Device according to claim 6, characterized in that the burner (B2) for generating the second flue gas (3) is connected to a feed appliance (9) via which the first flue gas that is cooled against the medium can be fed as oxidizing agent thereto.

10. Device according to claim 1, characterized in that it can be used for vaporizing and/or warming liquid natural gas or liquid ethylene or liquid nitrogen or carbon dioxide.
